(19) United States
(12) Patent Application Publication
(10) Pub. No.: US 2014/0081618 A1
(43) Pub. Date: Mar. 20, 2014

(54) DESIGNING A WEBSITE TO BE DISPLAYED IN MULTIPLE LANGUAGES

(71) Applicant: salesforce.com, inc., San Francisco, CA (US)

(72) Inventor: Hyejin Kim, San Francisco, CA (US)

(73) Assignee: salesforce.com, inc., San Francisco, CA (US)

(21) Appl. No.: 14/021,893

(22) Filed: Sep. 9, 2013

Related U.S. Application Data
(60) Provisional application No. 61/702,038, filed on Sep. 17, 2012.

(51) Int. Cl. G06F 17/28

(52) U.S. Cl. CPC G06F 17/289
USPC 704/2

(57) ABSTRACT

A method for building websites including at least one language translation is provided. The method incorporates a language translation into an individual website having a default display language, wherein the step of incorporating comprises saving the language translation as part of the individual website, and wherein the language translation is available for viewing at the individual website; and adds a language switching feature to the individual website, the language switching feature enabling an end-user to change the default display language of the individual website to the language translation.

### CROSS-REFERENCE TO RELATED APPLICATION(S)

This application claims the benefit of U.S. provisional patent application Ser. No. 61/702,038, filed Sep. 17, 2012.

### TECHNICAL FIELD

Embodiments of the subject matter described herein relate generally to the use of website development tools. More particularly, embodiments of the subject matter relate to utilizing a website development tool to incorporate multiple translations into one website.

### BACKGROUND

The internet is accessible worldwide, and to users who speak a multitude of languages. Businesses and private citizens conduct business and communicate via websites. Websites are generally developed in one language, but users who speak any number of different languages may wish to have access to a single website. Large corporations may require their website be presented using ten or even twenty different languages, for example. To accomplish this, a website will be copied and then translated, producing an individual website for each translation.

Accordingly, it is desirable to incorporate multiple languages into a single website, and to allow a user to select a display language according to his/her preference. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic block diagram representation of a computer system used in website development, according to some embodiments;

FIGS. 2A-2D illustrate exemplary displays that may be generated during use of a website development tool of the type described herein; and

FIG. 3 is a flow chart that illustrates a method for incorporating language translation features into a website, according to some embodiments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following

### DETAILED DESCRIPTION

The subject matter presented herein relates to the use of a website development tool to incorporate language translations, and language translation features, into a website. More specifically, a website development tool provides a graphical user interface (GUI), from which a website developer may generate one or more language translations for a website, and incorporate the language translation(s) into the single, individual website. In addition, the GUI may be used to insert features for selecting an available language translation in which to view the website, and to manually select portions of a website to exclude from translation.

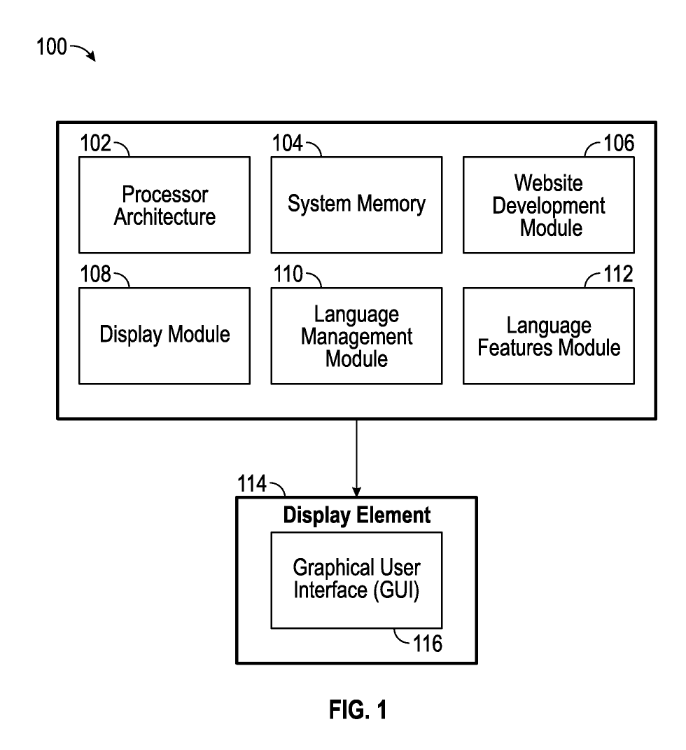

Referring now to the drawings, FIG. 1 is a schematic block diagram representation of modules of a computer system 100, according to some embodiments. The computer system 100 may be implemented using any desired platform. For example, the computer system 100 could be realized as any of the following, without limitation: a desktop computer, laptop computer, server, or any other device that includes a processor architecture 102. Additional components such as displays and user input components may be employed without departing from the scope of the present disclosure.

In certain embodiments, the modules of the computer system 100 include, without limitation: a processor architecture 102, system memory 104, a website development module 106, a display module 108, a language management module 110, and a language features module 112. These modules may be implemented using software, hardware, firmware, processing logic, or any combination thereof. Furthermore, these modules (e.g., instructions and/or code implementing these modules) may be stored in a computer-readable medium of the computer system 100. The computer-readable medium may include system memory (e.g., DRAM, etc.), non-volatile memory devices, volatile memory devices, and the like.

The processor architecture 102 may be implemented or performed with one or more general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In particular, the processor architecture 102 may be realized as one or more microprocessors, controllers, microcontrollers, or state machines. Moreover, the processor architecture 102 may be implemented as a combination of computing devices, e.g., a combination of digital signal processors and microprocessors, a plurality of microprocessors, one or more microprocessors in conjunction with a digital signal processor core, or any other such configuration.

The system memory 104 may be realized using any number of devices, components, or modules, as appropriate to the embodiment. Moreover, the computer system 100 could include system memory 104 integrated therein and/or system memory 104 operatively coupled thereto, as appropriate to the particular embodiment. In practice, the system memory 104 could be realized as random access memory (RAM), flash memory, erasable programmable read only memory (EPROM), electrically erasable programmable read only memory (EEPROM), registers, a hard disk, a removable disk, or any other form of storage medium known in the art. In certain embodiments, the system memory 104 includes a hard disk, which may also be used to support functions of the computer system 100. The system memory 104 can be coupled to the processor architecture 102 such that the processor architecture 102 can read information from, and write information to, the system memory 104. In the alternative, the system memory 104 may be integral to the processor architecture 102. As an example, the processor architecture 102 and the system memory 104 may reside in a suitably designed application-specific integrated circuit (ASIC).

The website development module 106 is suitably configured to construct and enhance a website in a user-friendly environment. The website development module 106 may be implemented as a tool for an end-user to create and add features to a website. In certain embodiments, the website development module 106 is implemented as an interface from which a user may build a website using various graphical elements displayed on a computer screen.

In certain embodiments, the website development module 106 may be installed locally on computer system 100 and locally executed for use on the computer system 100. In exemplary embodiments, the website development module 106 may be server-based or internet website-based, in which the website development module 106 is installed in a location that is remote from the computer system 100. In this situation, the website development module 106 may be executed at the computer system 100 or may be executed at a remote location for use at the computer system 100.

The computer system 100 includes a display module 108, which cooperates with a display element 114. The display module 108 generates display information for the computer system 100, which is rendered on the display element 114 in a manner that results in one or more graphical user interfaces (GUIs) 116 displayed on the display element 114.

From a GUI 116, a user may select options and features and incorporate them into a website that is being developed. The GUI 116 may include or cooperate with various software elements of the computer system 100 to allow a user to interact with the website development module 106. Accordingly, the GUI 116 may include various interactive software features, e.g., menus, drop-down lists, icons, buttons, checkboxes, or any software component that enables the user to select options, input information, or otherwise control the operation of the website development module 106. For example, the GUI 116 could be manipulated by an operator to select an available language translation for material displayed on a website, and incorporate the available language translation into the website, as described below.

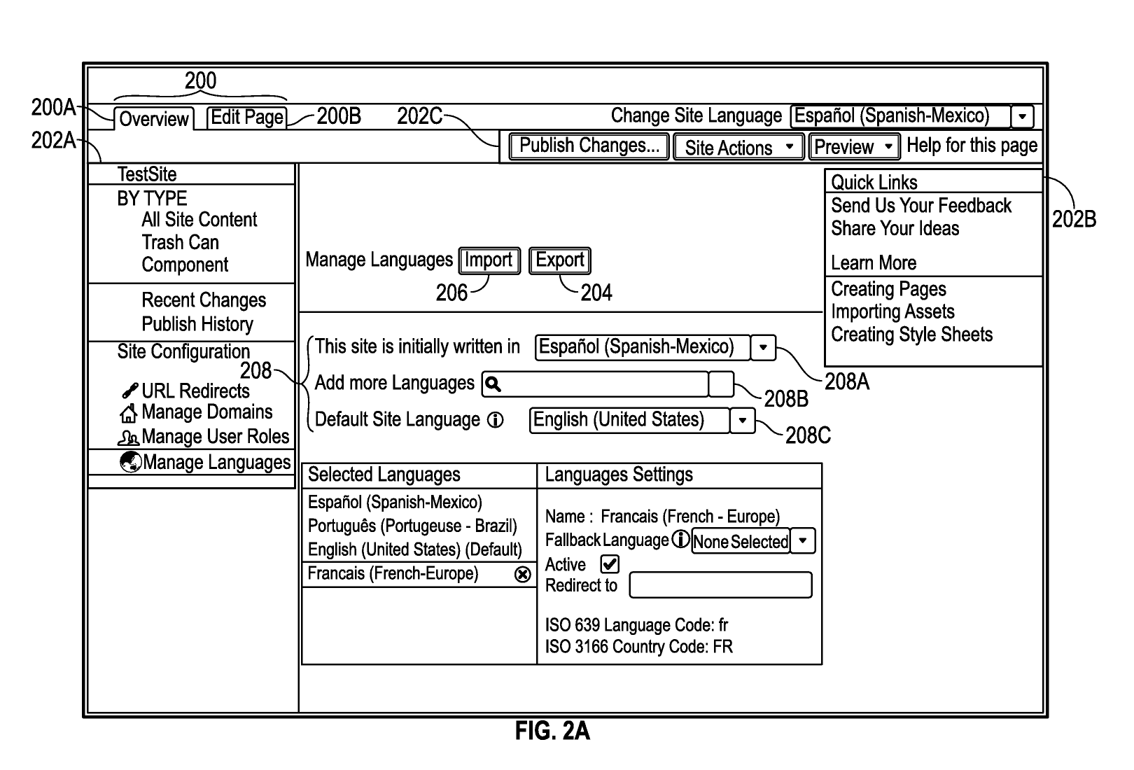

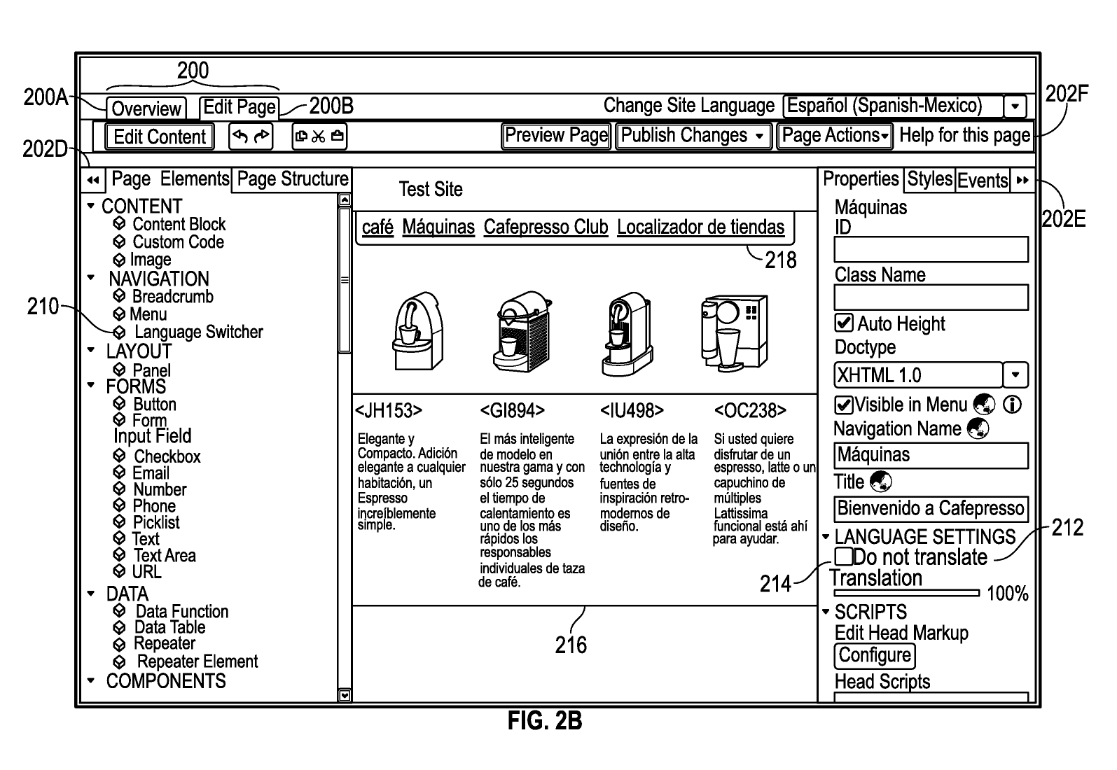

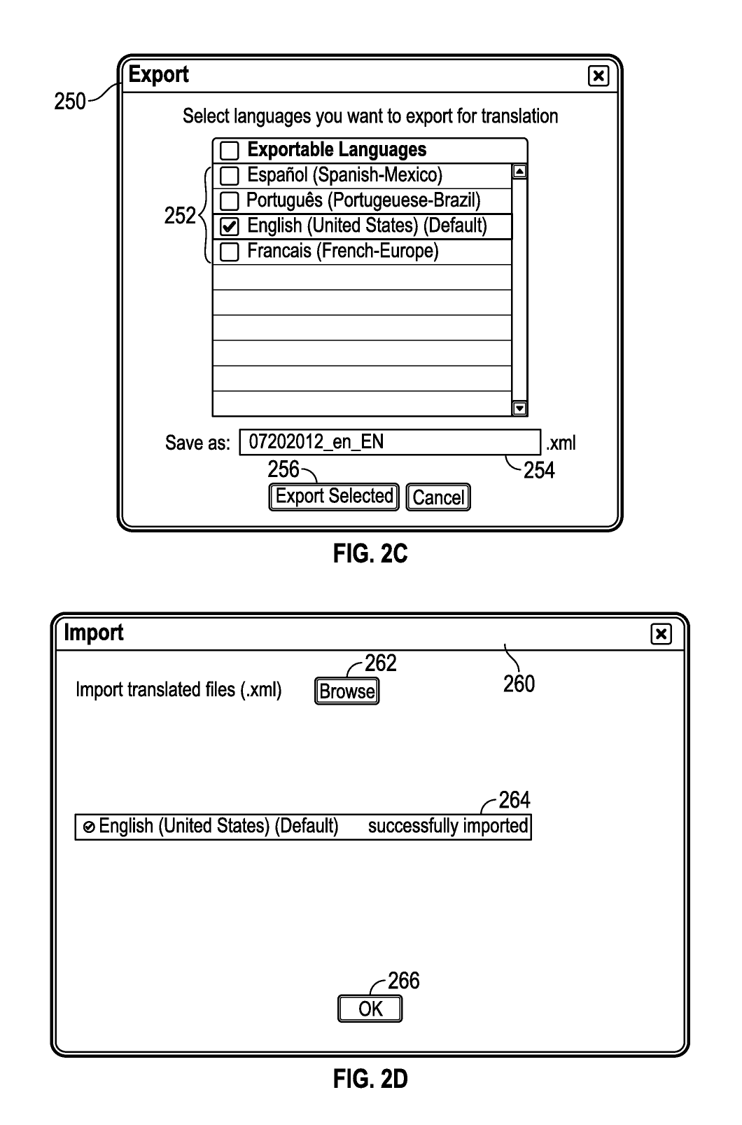

In certain embodiments, the GUI 116 may be implemented using various screens, pages, dialog boxes, and other user-interactive graphics. In some embodiments, the GUI 116 includes page tabs 200 (shown in FIGS. 2A and 2B) from which a user may select an Overview tab 200A or an Edit Page tab 200B. The Overview tab 200A presents a user with editing menus 202A, 202B, 202C from which to manage content for a website or to search available website construction assistance in the form of “Help” content. The Edit Page tab 200B presents a user with editing menus 202D, 202E, 202F from which to incorporate additional features into a website, including language features, or to access “Help” content.

The language management module 110 is suitably configured to designate a language translation associated with a website as a default language and/or a language in which the website was originally written. In addition, the language management module is configured to add additional language translations to a website. In certain embodiments, these designations and additions may be input via drop-down menus 208, shown in FIG. 2A. Utilizing drop-down menu 208A a user may select one language, from the available language translations of a website, to designate as an initial language. Similarly, utilizing drop-down menu 208C, a user may select one default language of the website, in which the website will be displayed to all users until an alternative translation is selected. Using drop-down menu 208B, a user may select one or more language translations to incorporate into a website.

The language management module 110 is also configured to obtain translated material for a website that is compatible with integration into the website. In certain embodiments, the language management module 110 creates a data file containing information for a website that is displayed using a specific language. In some embodiments, the data file is formatted as an Extensible Markup Language (XML) file. This data file is exported for translation into one or more additional languages by an outside translator or translation source. Once the data file has been translated, the language translation module imports the translated data file and incorporates the translated material into the website.

FIG. 2A illustrates an exemplary embodiment of a GUI (shown as 116 in FIG. 1) that provides a user, such as a website developer, with the functionality necessary to obtain a language translation for a website. In certain embodiments, a user may click on an export button 204, which creates the data file containing all text data that is displayed on the website. Generally, this text data is created and displayed in one specific language, such as English, and in this example, the newly created data file will include data in English.

To obtain a translation, for example, a website developer may be constructing and/or editing Website A using the GUI shown in FIG. 2A, which is provided by a website development module (shown as 106 in FIG. 1). The website developer may have developed Website A in Spanish, and wish to incorporate an English translation into Website A. The website developer may click on export button 204 to open up export dialog box 250, shown in FIG. 2C. Export dialog box 250 contains a list of available language translation options 252 for Website A material. From export dialog box 250, the website developer may select a language translation option 252 and input a file name 254 for saving the XML data file that will be created from Website A material. In this example, the website developer selects English from the available language translation options 252, in order to obtain a Spanish to English translation of Website A material.

Here, the list of available language translation options 252 is populated with options selected by the website developer using drop-down menu 208B (shown in FIG. 2A) for adding additional languages to the website. Once the website developer has selected a language translation option and input a preferred file name for the XML data file, the website developer clicks the “Export Selected” button 256. The XML data file is then created and exported for translation.

Once the XML data file containing Spanish Website A material has been translated into English, a new data file containing the English Website A material is received by the website developer. The website developer may utilize the language management module 110 (shown in FIG. 1), and its associated GUI shown in FIG. 2A, to import the English material into Website A. In this example, the website developer may click import button 206 to open import dialog box 260 (shown in FIG. 2D). From import dialog box 260, the website developer may click browse button 262 to open a new dialog box (not shown) to search for and select the English XML data file from the website developer's computer system. The import dialog box 260 displays a “successfully imported” message 264 once the translated XML data file has been selected and the language management module has imported the newly translated material. From here, the website developer may click the “OK” button 266 to return to the Manage Languages screen shown in FIG. 2A. At this point, Website A includes Spanish and English translations, for selection and viewing by a user.

Returning to FIG. 1, the language features module 112 is suitably configured to utilize and/or incorporate various available language features into a website. These language features may include, without limitation: a language switching feature, a manual data entry feature, a translation exemption feature, and a display feature to show how much of the website material has been translated. In certain embodiments, a website developer utilizes the functionality of a GUI 116, such as that illustrated in FIG. 2B, to select from among the available language features and to incorporate the selected language features into the website.

FIG. 2B illustrates an exemplary embodiment of a GUI (shown as 116 in FIG. 1) that provides a user, such as a website developer, with available language features for incorporation into a website from the Edit Page tab 200B. As shown, editing menus 202D, 202E, 202F frame (i.e., surround) a user-selected page of the website under construction, and the user may edit the page using the options presented. For example, a language switching feature may be incorporated by dragging and dropping the Language Switcher 210 icon from editing menu 202D into the page. As another example, a user may select any of the text 216, 218 and designate the selection as exempt from translation by checking the “Do not translate” 212 box of the editing menu 202E. A user may also manually edit text 216, 218 of the page, by typing into a dialog box that is presented after clicking on a specific section.

In addition to the previously described language features, a translation status bar 214 displays a percentage of website material that has been translated. Generally, when a translation for a website is obtained, a data file is created using website material, including all displayed text. When the website material is translated and incorporated into the website, the translation status bar would indicate that 100% of the website material has been translated. However, in some embodiments, a user will designate certain portions of website material as exempt from translation by selecting the designated portions and checking the “Do not translate” box 212 before creating and exporting a data file for translation. For example, a user may designate 10% of website material as exempt from translation, by clicking on 10% of the displayed material. In this example, once the translated material is incorporated into the website, the translation status bar 214 will indicate that 90% of website material has been translated. In another example, 100% of website material may be translated and incorporated into the website, but the user may continue to edit the website, and to eventually change 15% of the website following translation. In this example, the translation status bar will show 100% immediately after translation, but will continue to decrease as the user makes changes, to settle on 85% when 15% of the website has been edited and is no longer translated.

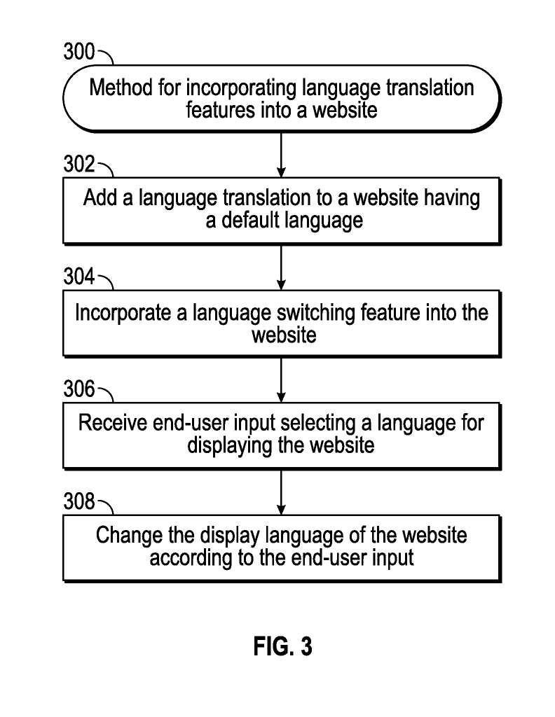

FIG. 3 is a flow chart that illustrates a method for incorporating language translation features into a website. The various tasks performed in connection with process 300 may be performed by software, hardware, firmware, or any combination thereof. For illustrative purposes, the following description of process 300 may refer to elements mentioned above in connection with FIGS. 1 and 2A-2D. In practice, portions of process 300 may be performed by different elements of the described system, e.g., the website development module, the language management module, or the language features module. It should be appreciated that process 300 may include any number of additional or alternative tasks, the tasks shown in FIG. 3 need not be performed in the illustrated order, and process 300 may be incorporated into a more comprehensive procedure or process having additional functionality not described in detail herein. Moreover, one or more of the tasks shown in FIG. 3 could be omitted from an embodiment of the process 300 as long as the intended overall functionality remains intact.

For ease of description and clarity, this example assumes that process 300 begins when a language translation is added to a website, when the website already has a default language (step 302). A user, such as a website developer, may add one or more language translations to the website, using a graphical user interface of a website development module. As described previously, a user may export website material for translation and import the new material once it has been translated. The translated and imported material is then available for viewing at the website. The language translation is incorporated into the website itself, and saved as a part of the website. Copies of the website are not generated to accommodate multiple language translations; all language translations that are incorporated into the website are located within a single, individual website.

Once the language translation has been added, the single, individual website includes at least two languages for viewing: the default language and the language translation. The language translation is now a permanent part of the website, unless removed. In certain embodiments, more than one language translation is incorporated into the website. For example, Website X may be originally created in German, and German may be designated as the default language for Website X. A user may wish to incorporate a translation of Website X in English. Once the English translation is incorporated into Website X, the English translation is a permanent part of Website X, unless it is removed by a user, such as a website developer.

Next, the process 300 incorporates a language switching feature into the website (step 304). As described previously, once one or more language translations have been incorporated into the website, a user may incorporate a language switching feature into the website, for alternating between the available languages to view. The language switching feature may include a list of options from which a user may select, such as a drop-down menu and/or a list accessible via link on the website. In certain embodiments, a user may select a language translation option by clicking on an option, marking a check-box next to an option, or any other method indicating selection on a website.

After the language switching feature has been incorporated into the website (step 304), the process 300 receives end-user input selecting a language for displaying the website (step 306). This end-user input may include selections and/or data entry within a website development tool. Next, the process 300 changes the display language of the website according to the end-user input (step 308), for viewing on a display.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for building websites including at least one language translation, the method comprising:
incorporating a language translation into an individual website having a default display language, wherein the step of incorporating comprises saving the language translation as part of the individual website, and wherein the language translation is available for viewing at the individual website; and
adding a language switching feature to the individual website, the language switching feature enabling an end-user to change the default display language of the individual website to the language translation.

2. The method of claim 1, wherein the language switching feature comprises a drop-down menu of a plurality of user-selectable language options for the individual website; and
wherein the plurality of user-selectable language options comprises one or more languages that have been incorporated into the individual website.

3. The method of claim 2, further comprising:
receiving end-user input selecting one of the plurality of user-selectable language options, via the drop-down menu; and
changing the default display language of the website according to the end-user input.

4. The method of claim 1, further comprising:
exporting a language file for translation, the language file comprising language data from the website;
importing a translation file, the translation file comprising language data that has been translated to a second language; and
incorporating the second language as a user-selectable language option on the website.

5. The method of claim 4, further comprising:
omitting a user-selected portion of the language data from the website, wherein the user-selected portion for omission is indicated in the language file.

6. The method of claim 1, further comprising:
exporting an extensible markup language (XML) language file for translation, the XML language file comprising language data from the website;
importing an XML translation file, the XML translation file comprising language data that has been translated to a second language; and
incorporating the second language as a user-selectable language option on the website.

7. The method of claim 1, further comprising selecting at least one part of the website to be omitted from translation.

8. The method of claim 1, further comprising:
calculating a percentage of the website that has been translated; and
displaying the calculated percentage graphically.

9. A graphical user interface for building a single website with language translation capabilities, the interface comprising:
a graphical display, configured to show website text in a default language;
language translation control elements, configured to incorporate a translation of the default language into the single website, wherein the step of incorporating comprises saving the translation of the default language as part of the single website, and wherein the translation of the default language is available for viewing at the single website; and
a language selection menu, configured to select one of a plurality of language options for viewing the single website, wherein the plurality of language options comprises the default language and the translation of the default language.

10. The graphical user interface of claim 9, further comprising a translation opt-out selection element, configured to select parts of the website to remain displayed in a default language when selects a translation in a language other than the default language.

11. The graphical user interface of claim 9, further comprising a translation status bar that indicates a percentage of parts of a website that have been translated.

12. The graphical user interface of claim 9, wherein the language selection menu is a drag-and-drop element configured to be moved from the interface onto the website.

13. The graphical user interface of claim 9, wherein the language control elements further comprise:
an export control element, configured to export a language file for translation, the language file comprising default language data from the website; and
an import control element, configured to import a translation file, the translation file comprising default language data that has been translated to a second language.

14. The graphical user interface of claim 9, further comprising:
manual entry control elements, configured to receive user-entered changes to the website.

15. A non-transitory, computer-readable storage medium containing instructions thereon for incorporating language translation features into a website, wherein, when the instructions are executed by a processor, the instructions cause the processor to:
provide a set of language translation features for an individual website;
receive input comprising selected features from the set of language translation features; and
maintain the selected features at the individual website.

16. The non-transitory, computer-readable storage medium of claim 15, wherein the selected features comprise a set of display language options for the individual website.

17. The non-transitory, computer-readable storage medium of claim 15, wherein, when the instructions are executed by the processor, the instructions further cause the processor to:
receive input regarding a user-selected display language for the website; and
display content of the website in the user-selected display language.

18. The non-transitory, computer-readable storage medium of claim 15, wherein, when the instructions are executed by the processor, the instructions further cause the processor to:
export a language file for translation, the language file comprising language data from the website;
import a translation file, the translation file comprising language data that has been translated to a second language; and
incorporate the second language as a user-selectable option on the website.

19. The non-transitory, computer-readable storage medium of claim 18, wherein, when the instructions are executed by the processor, the instructions further cause the processor to:
omit a user-selected portion of the language data from the website, wherein the user-selected portion for omission is indicated in the language file.

20. The non-transitory, computer-readable storage medium of claim 15, wherein, when the instructions are executed by the processor, the instructions further cause the processor to:
provide a visual display of translation progress for the website, wherein the visual display shows a ratio of website material that has been translated.
